(19) United States
(12) Patent Application Publication
(10) Pub. No.: US 2009/0038483 A1
(43) Pub. Date: Feb. 12, 2009

(54) High density disk and ellipse for cooking pizza

(76) Inventor: Dino Scorziello, Delmont, PA (US)

Correspondence Address: DINO SCORZIELLO, 102 VALLEY STREAM DR., APT. 1D, DELMONT, PA, 15626, US

(21) Appl. No.: 11/890,245

(22) Filed: Aug. 6, 2007

(51) Int. Cl. H05B 6/12

(52) U.S. Cl. 99/450; 219/621

(57) ABSTRACT

To prevent pizza from being served with raw dough in the center, a pizza (20) is placed on top of a dense preheated disk (10) in order to cook the center of the pizza. The heat contained within a preheated disk is transferred to the center of said pizza causing it to be cooked uniformly. A dense ellipse (30) is available for rectangular pizzas (40). A pizza tray with a built-in disk (50) or ellipse (30) is also described.

### CROSS-REFERENCE TO RELATED APPLICATIONS

Not applicable.

### BACKGROUND

1. Field of Invention

This invention relates to food cooking devices specifically devices used to cook pizza.

2. Description of Prior Art

Pizza is a popular food item. However due to its shape and profile it is difficult to make a pizza that is cooked evenly. In an attempt to quickly serve its customers many restaurants and pizzerias serve undercooked pizza even though the toppings and edge are done. Typically the dough at the center of a pizza is under cooked or raw even though the toppings of the pizza are cooked. This is because the toppings of a pizza act as insulation preventing heat from the oven from penetrating the center of the pizza and cooking the dough. One also risks burning a pizza if it is left to cook for a longer period of time just to ensure its center is cooked. This is because heat absorbed from the edge of the pizza is used to cook the outer sections of the pizza before sufficient heat is allowed to be conducted in toward the center to cook it.

If pizza is placed on the floor of an oven it absorbs any heat present. However the pizza now prevents the bottom of the oven from getting hot because it doesn't allow hot air to come in contact with the oven floor. Also, when the bottom of the pizza begins to cook it acts like a layer of insulation preventing heat from being conducted from the oven floor to the center of the pizza. The pizza dough contains entrapped air bubbles that have good insulation properties. If the pizza were placed on a pizza tray and placed on a rack in the oven to allow air to circulate, the bottom would still act as insulation slowing the cooking progress of the center of the pizza. Therefore, in order to make a thoroughly cooked pizza one risks burning portions of it. It would be advantageous to have a device that could put extra heat in towards the center of the pizza so it could cook in the same amount of time as the outer portions of the pizza. Restaurants using this device would have an advantage because they could serve thoroughly cooked pizza to their customers and gain a reputation for producing good well cooked pizza. Families that make pizza at home can use this device to thoroughly cook their pizzas without burning it.

### SUMMARY

In accordance with the present invention, a high density heat resistant disk is placed under the center of a pizza to transfer more heat to the center of the pizza in order to help it cook in the same amount of time as the outer portions of the pizza.

### OBJECTS AND ADVANTAGES

Accordingly, several objects and advantages of my invention are:

a) to provide restaurants the means to prepare thoroughly cooked pizza.
b) to prevent people from burning their pizzas while they attempt to thoroughly cook it.
It will also allow restaurants that do not serve pizza, due to the length of time it takes to prepare, the opportunity to add pizza to their menus. Still further objects and advantages will become apparent from a consideration of the ensuing description and drawing.

### DRAWING FIGURES

FIG. 1 shows a high density disk from the top and in cross section.

FIG. 2 shows a top view of a pizza on top of a high density disk.

FIG. 3 shows a top view of a rectangular pizza on a high density ellipse.

FIG. 4 shows a pizza tray with a built-in high density disk from the top and in cross section.

FIG. 5 shows a rectangular pizza tray with a built-in high density ellipse from the top and in cross section.

### REFERENCE NUMERALS IN DRAWINGS

| | |
|---|---|
| 10 | high density disk |
| 11 | top surface |
| 12 | base |
| 20 | pizza |
| 30 | high density ellipse |
| 40 | rectangular pizza |
| 50 | round pizza tray |
| 60 | rectangular pizza tray |

### DESCRIPTION

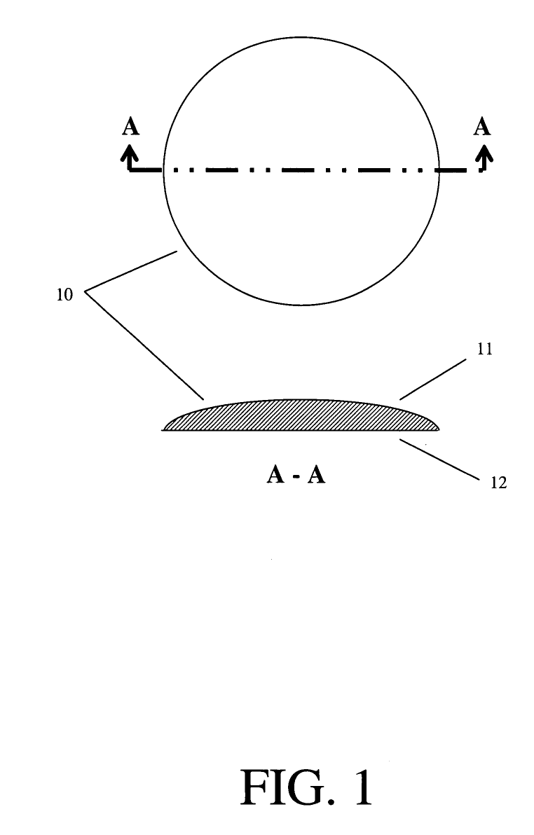

### FIG. 1

### Preferred Embodiment

FIG. 1 shows a high density disk 10. It can be made of metals such as steel, cast iron, aluminum, copper or any other metallic alloys. It can also be made of stone such as granite, marble or any other desired stone. It cannot be made of pumice or other similar nonconductive insulating material. It can also be made from ceramics or ceramic/metallic (metals contained within ceramics) materials. The material should be heat resistant and should have a specific gravity greater than 1.10.

The disk 10 has a base 12 and a top surface 11 that slopes downward to meet the base 12. A minor third surface is included at the circumference, perpendicular to the base preventing sharp edges. The height of the disk at its center is greater than about half an inch. The diameter of the disk is less than about half the diameter of the pizza being cooked.

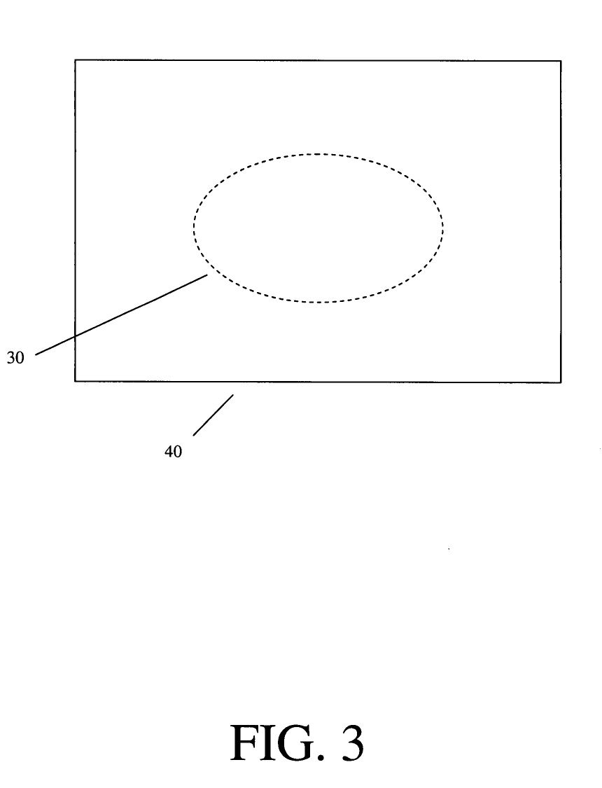

### FIGS. 3-5

### Additional Embodiments

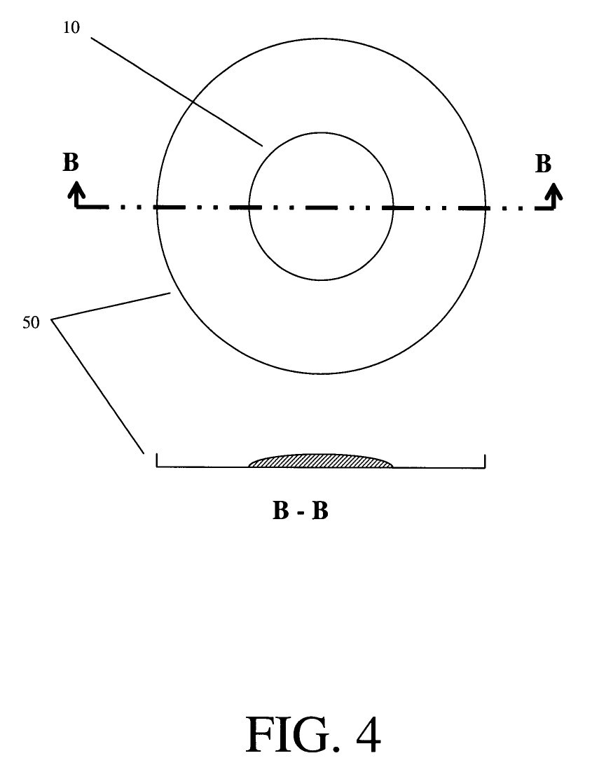

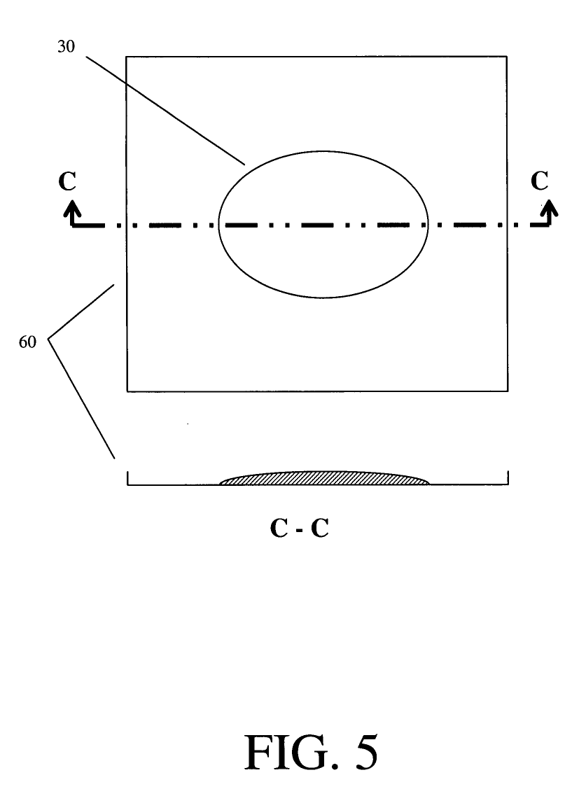

Another embodiment would be a high density ellipse 30 for cooking rectangular pizza 40 (big party pizza) as shown in FIG. 3. The long axis of the ellipse would be about half the length of the long axis of the rectangular pizza. The short axis of the ellipse would be about half the length of the short axis of the rectangular pizza. Another embodiment would be a pizza tray 50 with a built-in high density disk 10 as shown in FIG. 4. Yet another embodiment would be a rectangular pizza tray 60 with a built-in high density ellipse 30 as shown in FIG. 5.

### ADVANTAGES

From the description above, several advantages of my high density disk for cooking pizza becomes evident:
(a) A dense material such as cast iron or granite will not burn in an oven.
(b) The acclivity of the disk puts more heat where it's needed in the center of the pizza.
(c) The disk can be made in different sizes and shaped to accommodate different sizes and shapes of pizza.

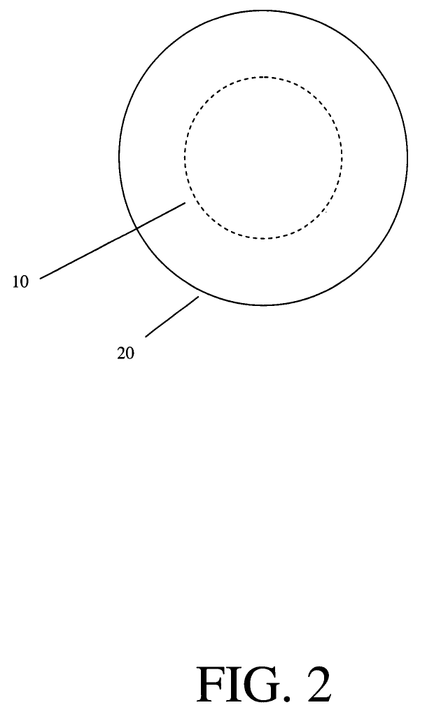

### Operation—FIGS. 2, 3, 4, 5

The manner of operating the high density disk 10 for cooking pizza 20 is illustrated in FIG. 2. The disk 10 is placed in an oven and allowed to be heated. Once the oven and high density disk 10 are preheated the pizza 20 is placed on top of the disk with its center over the disk's center, and cooked normally. During the cooking process the heat from the high density disk is transferred to the center of the pizza allowing it to cook at the same rate that the outer portion of the pizza is cooked. The high density disk causes the entire pizza to be cooked uniformly.

FIG. 3 shows how a rectangular pizza 40 is cooked using a high density ellipse 30. The ellipse 30 is placed in an oven and allowed to be heated. Once the oven and high density ellipse 30 are preheated the rectangular pizza 40 is placed on top of the ellipse with its center over the ellipse's center. The long axis of the rectangular pizza 40 must line up with the long axis of the high density ellipse 30. The pizza is allowed to cook normally. During the cooking process the heat from the high density ellipse 30 is transferred to the center of the rectangular pizza 40 allowing it to cook at the same rate that the outer portion of the pizza is cooked. The high density ellipse 30 causes the entire pizza to be cooked uniformly.

FIG. 4 shows a round pizza tray 50, with a built-in high density disk 10. This entity allows people to prepare pizza at home in their own ovens. It is convenient because people don't have to search for a separate disk and a separate tray. The unit works by placing it into an oven and preheating it. Once it is heated the pizza is placed on to it and allowed to cook. During the cooking process the heat from the high density disk is transferred to the center of the pizza allowing it to cook at the same rate that the outer portion of the pizza is cooked. The high density disk causes the entire pizza to be cooked uniformly.

FIG. 5 shows a rectangular pizza tray 60, with a built-in high density ellipse 30. This entity allows people to prepare rectangular pizza 40 at home in their own ovens. It is convenient because people don't have to search for a separate ellipse and a separate tray. The unit works by placing it into an oven and preheating it. Once it is heated a rectangular pizza is placed on to it and allowed to cook. The long axis of the rectangular pizza must line up with the long axis of the high density ellipse. During the cooking process the heat from the high density ellipse is transferred to the center of the pizza allowing it to cook at the same rate that the outer portion of the pizza is cooked. The high density ellipse causes the entire pizza to be cooked uniformly.

### CONCLUSION, RAMIFICATIONS AND SCOPE

Accordingly, the reader will see that the high density disk for cooking pizza is a helpful kitchen accessory that people and restaurants can use to prepare fully cooked pizza. Pizza with raw dough in the center can now be prevented by utilizing the high density disk. This will increase diner's enjoyment of pizza and strengthen the reputation of restaurants that utilize the high density disk or ellipse.

While my above description contains many specificities, these should not be construed as limitations on the scope of the invention, but rather as an exemplification of one preferred embodiment thereof. Accordingly, the scope of the invention should be determined not by the embodiment illustrated but by the appended claims and their legal equivalents.

I claim:

1. A disk for cooking the center of pizzas comprising:
a. a diameter of about half the diameter of a pizza;
b. a top surface with an acclivity towards the bottom surface;
c. a heat resistant material with a specific gravity of about 1.1 or greater;
whereby the heat contained within a preheated disk is transferred to the center of said pizza causing said pizza to be cooked uniformly.

2. A round pizza tray with the disk of claim 1 built integral to it.

3. An ellipse for cooking the center of rectangular pizzas comprising:
a. a long axis of about half the length of the long axis of a rectangular pizza;
b. a short axis of about half the length of the short axis of a rectangular pizza;
c. a top surface with an acclivity towards the bottom surface;
d. a heat resistant material with a specific gravity of about 1.1 or greater;
whereby the heat contained within a preheated ellipse is transferred to the center of said rectangular pizza causing said pizza to be cooked uniformly.

4. A rectangular pizza tray with the ellipse of claim 3 built integral to it.
